(19) United States
(12) Patent Application Publication
(10) Pub. No.: US 2026/0166774 A1
(43) Pub. Date: Jun. 18, 2026

(54) HEAT CURING SYSTEM FOR CONCRETE

(71) Applicant: PINECO CO., LTD., Seoul (KR)

(72) Inventors: Jungkyu PARK, Seongnam-si (KR); Joonwoo PARK, Seongnam-si (KR); Changju KIM, Incheon (KR); Sangjoon KANG, Seoul (KR); Gunju RYU, Yangsan-si (KR)

(21) Appl. No.: 19/533,102

(22) Filed: Feb. 6, 2026

Related U.S. Application Data
(63) Continuation of application No. PCT/KR2024/017343, filed on Nov. 6, 2024.

(30) Foreign Application Priority Data
Nov. 6, 2023 (KR) 10-2023-0151392
May 21, 2024 (KR) 10-2024-0065806

(51) Int. Cl. B28B 11/24; H05B 1/02; H05B 3/22

(52) U.S. Cl. CPC B28B 11/245; H05B 1/023; H05B 3/22

(57) ABSTRACT

Provided is a heat-generating curing system for concrete including: an upper assembly including a plate portion formed in a plate shape and a plurality of peripheral frames coupled to the plate portion, wherein a predetermined space is formed therein so that concrete is placed therein; a plate-shaped heating assembly positioned in close contact with one side surface of the plate portion and configured to generate heat by power supply; a power supply unit configured to supply power to the heating assembly; and a control unit configured to control a heating temperature and a heating time of the heating assembly. In this case, the upper assembly includes a plurality of piezoelectric sensors configured to measure a weight of concrete placed in the predetermined space, and the control unit controls the heating assembly based on information received from the plurality of piezoelectric sensors.

### BACKGROUND

### Technical Field

The present invention relates to a heat-generating curing system for concrete.

### Background Art

Concrete is a construction material produced by mixing cement, fine aggregate, coarse aggregate, water, and the like, and in a production stage, raw materials are mixed at predetermined ratios and poured into a structure for placement. Concrete hardens over time by a hydration reaction, and strength is developed. Curing of concrete refers to appropriately controlling temperature and humidity until the concrete hardens after mixing so that sufficient hardening strength can be exhibited, and means protecting the concrete so that excessive impact or load is not applied until the concrete has sufficient strength, and protecting exposed surfaces of the concrete against wind and rain, frost, and sunlight.

Depending on ambient temperature conditions, curing conditions can be largely classified into three types, and can be divided into: 1) hot weather concrete, 2) normal concrete, and 3) cold weather concrete conditions. In the case of hot weather concrete, this corresponds to days on which a daily average temperature exceeds 25° C., and corresponds to approximately 1 to 2 months based on Korea's 2021 temperature data. In the case of cold weather concrete, this corresponds to conditions of 5° C. or less, and corresponds to approximately 4 to 5 months based on Korea's 2021 temperature data.

In domestic concrete practice manuals, when a daily average temperature on a cold weather concrete placement day is 4° C. or less, or when a daily minimum temperature of 0° C. or less is expected during 24 hours after placement, concrete may freeze, and thus it is stipulated that initial thermal insulation curing for two days from a placement time point be performed. At the time of placement, the temperature of the concrete shall be maintained at 5° C. or higher, and when a thickness of the concrete being produced is 300 mm or less, it is stipulated that a minimum temperature of the concrete be secured at 10° C. or higher.

Curing methods for winter concrete used to maintain temperature conditions of concrete placed during a winter season can be largely divided into a thermal insulation curing method and an accelerated curing method, and a combined curing method in which the two methods are mixed may be implemented by a field engineer.

The curing method most commonly used at construction sites is a thermal insulation curing method, and the thermal insulation curing method can be further divided into an insulation-based thermal curing method and a heated thermal curing method. In detail, in the case of the insulation-based thermal curing method, air caps, bubble sheets, and the like are typically used and are used for the purpose of preventing initial frost damage of concrete in winter, and the heated thermal curing method is used for the purpose of preventing initial poor hardening and cracks caused by surface drying shrinkage by delivering optimal heat to a concrete structure using heat-generating devices such as hot air blowers and heating wires.

In the case of an accelerated curing method, a moist curing method using steam is representative. A case in which humidity is controlled by using water vapor or a humidifying device during a process in which concrete hardens is referred to as “moist curing.” In a production process of precast concrete products, moist curing using steam is widely utilized. When moist curing is utilized, an appropriate amount of moisture is supplied to exposed surfaces, or evaporation of moisture due to wind or direct sunlight is prevented, thereby maintaining a uniform surface without cracks or damage. However, since moist curing increases a temperature of an entire space without directly delivering energy to a formwork, energy consumption is very large and efficiency is low. In addition, there are problems in that a steel formwork is corroded by steam, thereby shortening a replacement cycle, and generation of harmful substances due to use of fossil fuels cannot be avoided.

A heat-generating curing technology is a construction method that accelerates curing of concrete by efficiently delivering uniform thermal energy to the concrete, and a basic principle thereof is to produce concrete of uniform quality by setting and controlling an optimal curing temperature for each structure and supplying heat at an appropriate temperature into a formwork.

In the case of a conventional curing method using attachment of a heating element, a heating element is installed on an outer wall of a formwork, and the attached heating element is configured in a form of a current resistance method. In order to use this, wires are arranged to supply electricity to the heating element, and since movement, installation, and dismantling of the formwork are repeatedly performed as a series of processes, exposed wires attached to the outer wall have a technical limitation in that workability is hindered.

The present invention aims to embed a heating element at a level that enables smooth production of concrete at a formwork manufacturing stage so that heat is generated over an entire surface on which concrete is placed, or at some important positions, thereby rapidly advancing hydration of the concrete. Structurally, a heating element and wires are embedded inside the formwork to minimize wires exposed to an outside, and the technology is improved so that a plurality of workers can easily and quickly use the same.

The heat-generating curing system for concrete of the present invention aims to deliver optimal heat by adjusting a direction of heat according to a degree of progress of curing in consideration of hydration characteristics of concrete, thereby allowing strength of the concrete to be rapidly and uniformly developed. In addition, when optimal hardening conditions are created through utilization of the present technology, strength of a concrete structure can be efficiently secured at an early stage, thereby intending to alleviate quality control problems and burdens of construction costs that have recently occurred frequently in the construction industry.

### SUMMARY

### Problem to be Solved

The present invention provides a curing heat-generating system for concrete that can significantly shorten a construction period by forming, inside a formwork, an ideal temperature condition capable of accelerating hardening of concrete by utilizing a heating element installed in the formwork, and can remarkably improve construction defects and workability.

However, technical problems to be achieved by the present embodiment are not limited to the technical problems as described above, and other technical problems may further exist.

### Means for Solving the Problem

A heat-generating curing system for concrete according to an embodiment of the present invention includes: an upper assembly including a plate portion formed in a plate shape and a plurality of peripheral frames coupled to the plate portion, wherein a predetermined space is formed therein so that concrete is placed therein; a plate-shaped heating assembly positioned in close contact with one side surface of the plate portion and configured to generate heat by power supply; a power supply unit configured to supply power to the heating assembly; and a control unit configured to control a heating temperature and a heating time of the heating assembly. In this case, the upper assembly includes a plurality of piezoelectric sensors configured to measure a weight of concrete placed in the predetermined space, and the control unit controls the heating assembly based on information received from the plurality of piezoelectric sensors.

### Effects of the Invention

According to the above-described means for solving the problems of the present invention, the present invention has an effect in that heat can be uniformly supplied to concrete being placed through a thin film heater, thereby enabling securing of uniform quality.

In addition, the present invention has an effect in that an amount of concrete being placed is accurately measured through piezoelectric sensors, and heat and time applied to the concrete are controlled, thereby enabling efficient curing of the concrete.

### BRIEF DESCRIPTION OF THE DRAWINGS

FIG. 1 is a plan view of a heat-generating curing system for concrete according to an embodiment of the present invention.

FIG. 2 is a front view and a partially enlarged view of the heat-generating curing system for concrete according to an embodiment of the present invention.

FIG. 3 is a front view of an upper assembly according to an embodiment of the present invention.

FIG. 4 is a bottom view of a heat transfer plate according to an embodiment of the present invention.

FIG. 5 is a plan view of a cover plate according to an embodiment of the present invention.

FIG. 6 is a front view of a lower assembly according to an embodiment of the present invention.

FIG. 7 is a plan view of a heat-generating curing system for concrete according to another embodiment of the present invention.

FIG. 8 is a front view of a heat-generating curing system for concrete according to another embodiment of the present invention.

FIG. 9 is a cross-sectional view of a cover portion according to an embodiment of the present invention.

### DETAILED DESCRIPTION

Hereinafter, embodiments of the present application will be described in detail with reference to the accompanying drawings so that those skilled in the art to which the present application pertains can easily carry out the present application. However, the present application may be embodied in many different forms and is not limited to the embodiments described herein. In addition, in order to clearly describe the present application in the drawings, portions irrelevant to the description are omitted, and similar reference numerals are assigned to similar parts throughout the specification.

Throughout the present specification, when a part is referred to as being “connected” to another part, this includes not only a case in which the part is “directly connected” but also a case in which the part is “electrically connected” with another element interposed therebetween. In addition, when a part is referred to as “including” a component, unless specifically stated otherwise, this means that other components are not excluded and may be further included, and it should be understood that this does not preclude the presence or addition possibility of one or more other features, numbers, steps, operations, components, parts, or combinations thereof.

The following embodiments are detailed descriptions for helping understanding of the present invention and do not limit the scope of the present invention. Accordingly, an invention within the same scope that performs the same function as the present invention will also fall within the scope of the present invention.

The present invention relates to a heat-generating curing system for concrete 10.

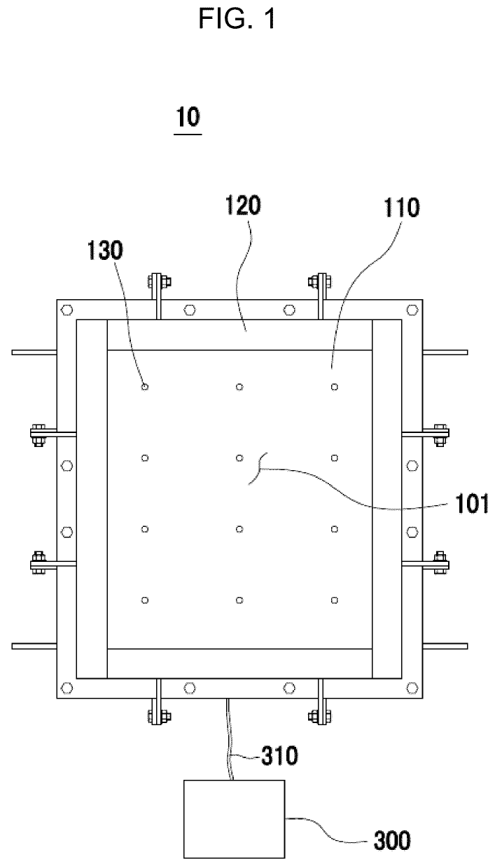

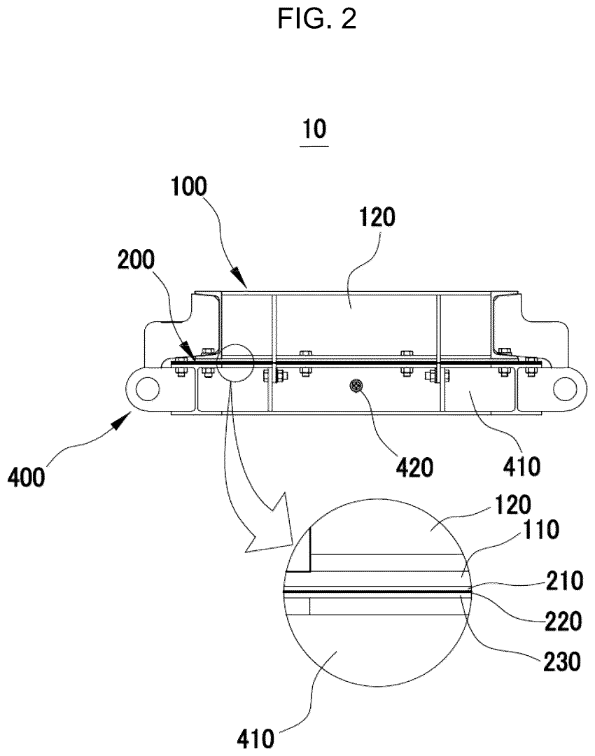

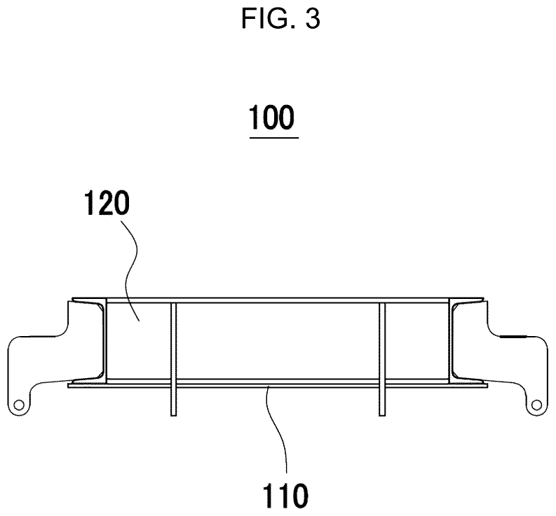

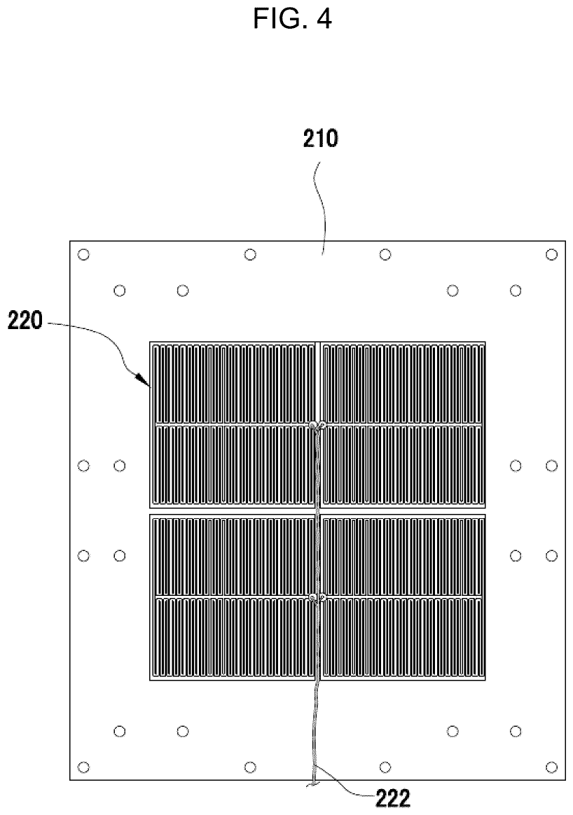

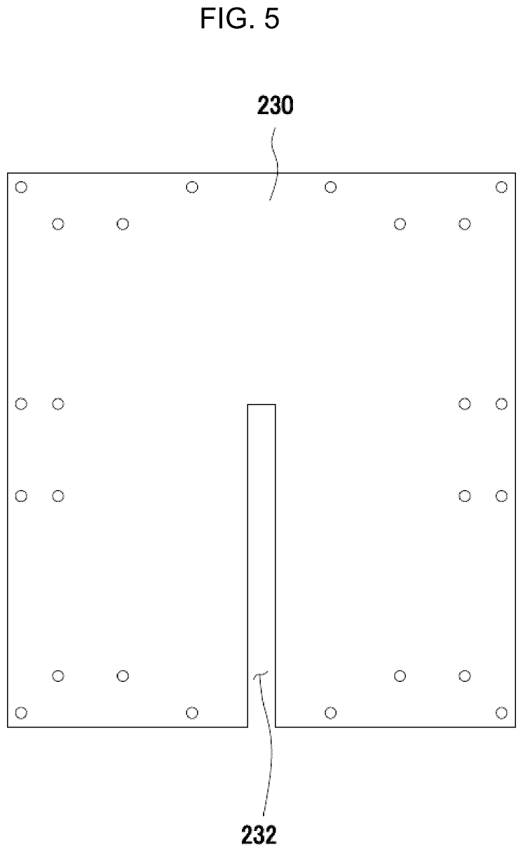

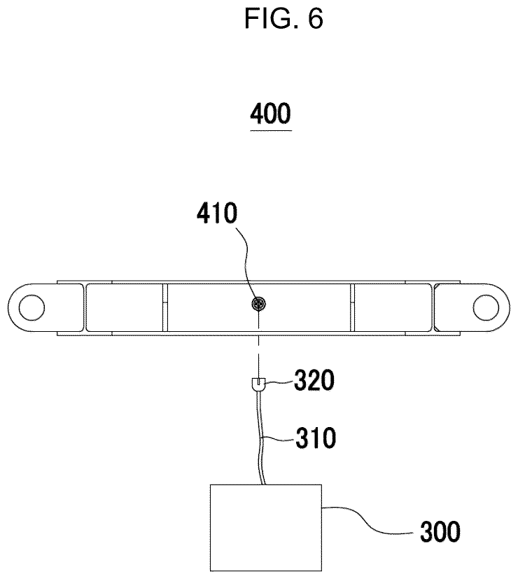

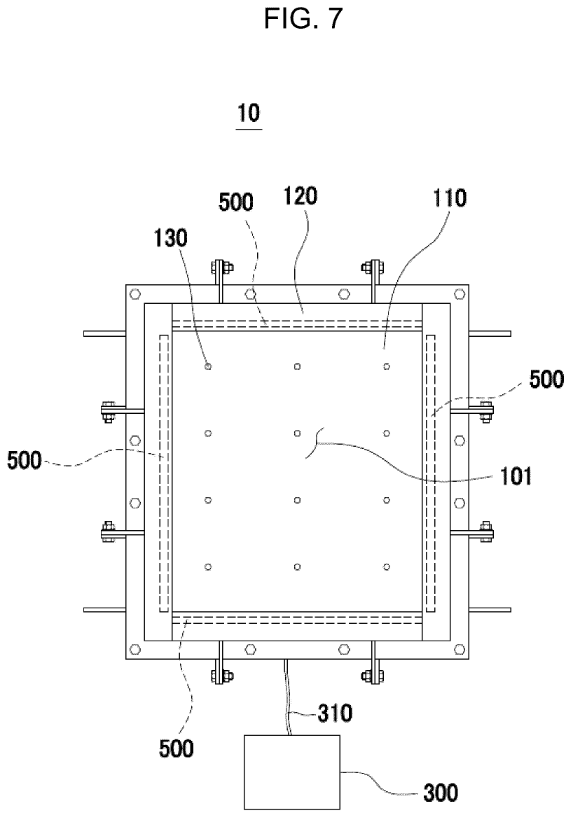

FIG. 1 is a plan view of a heat-generating curing system for concrete 10 according to an embodiment of the present invention, FIG. 2 is a front view and a partially enlarged view of the heat-generating curing system for concrete 10 according to an embodiment of the present invention, FIG. 3 is a front view of an upper assembly 100 according to an embodiment of the present invention, FIG. 4 is a bottom view of a heat transfer plate 210 according to an embodiment of the present invention, FIG. 5 is a plan view of a cover plate 230 according to an embodiment of the present invention, FIG. 6 is a front view of a lower assembly 400 according to an embodiment of the present invention, and FIG. 7 is a plan view of a heat-generating curing system for concrete 10 according to another embodiment of the present invention.

Hereinafter, with reference to FIGS. 1 to 6, a heat-generating curing system for concrete 10 according to one embodiment of the present invention will be described.

Referring to FIGS. 1 and 2, the heat-generating curing system for concrete 10 according to an embodiment of the present invention includes an upper assembly 100, a heating assembly 200, a power supply unit 300, and a control unit (not shown).

The upper assembly 100 may form a formwork in which a predetermined space is formed so that concrete is placed therein. In other words, the upper assembly 100 includes a plate portion 110 formed in a plate shape and a plurality of peripheral frames 120 coupled to the plate portion 110, and as the plurality of peripheral frames 120 are fixed to the plate portion 110, a space in which concrete is placed may be formed. For example, as shown in FIGS. 1 and 2, the peripheral frames 120 may be formed to have a ‘C’-shaped cross-section. In addition, four peripheral frames 120 are fixed to one side surface of the plate portion 110 formed in a plate shape in a state in which ends thereof are in close contact with each other, thereby forming a rectangular parallelepiped space in which concrete is placed.

In addition, the upper assembly 100 includes a plurality of piezoelectric sensors 130 configured to measure a weight of concrete placed in the predetermined space. For example, as shown in FIG. 1, the plurality of piezoelectric sensors 130 may be arranged in a grid pattern on one side surface of the plate portion 110 in order to appropriately sense pressure applied by the concrete being placed, but the present invention is not limited thereto.

The piezoelectric sensors 130 may utilize a piezoelectric effect in which materials such as quartz (SiO₂), lead zirconate titanate (PZT), and the like generate electric charge in response to mechanical stress. The piezoelectric sensors 130 are essentially used in application fields in which force or pressure changes must be accurately sensed, and are capable of converting mechanical energy into electrical signals. It is important to understand an operating principle of the piezoelectric sensors 130, in that when mechanical force is applied, a resistance of the piezoelectric sensors 130 does not change significantly and proportional electrical output can be obtained. Due to such characteristics, the piezoelectric sensors 130 are suitable for dynamic pressure measurement tasks such as monitoring a weight when concrete is placed. Meanwhile, the piezoelectric sensors 130 may be replaced with pressure sensors, as necessary.

Referring to FIG. 2, the heating assembly 200 is formed in a plate shape, is positioned in close contact with one side surface of the plate portion 110, and generates heat by power supply. That is, the heating assembly 200 generates heat by receiving power from a power supply unit 300 to be described later, and supplies generated thermal energy to the plate portion 110 to transfer heat to the placed concrete. A detailed description thereof will be provided later.

Referring again to FIG. 1, the power supply unit 300 supplies power to the heating assembly 200. In this case, the power supply unit 300 may transmit power to the heating assembly 200 through a power supply line 310.

The control unit controls a heating temperature and a heating time of the heating assembly 200. In addition, the control unit controls the heating assembly 200 based on information received from the plurality of piezoelectric sensors 130.

In detail, before starting concrete placement, the control unit sets values received from the piezoelectric sensors 130 as reference values without applying weight, and may perform calibration and correction so as to recognize an expected pressure change range during concrete placement. Next, the control unit calculates a volume and a weight of the concrete based on information received from the piezoelectric sensors 130, and may control a heating temperature and a heating time of the film heater 220.

In addition, for the purpose of automatic control, integrating the piezoelectric sensors 130 with the film heater 220 may include using electrical signals generated by the piezoelectric sensors 130 to regulate heating activity. This process generally requires an intermediate electronic circuit or control system capable of interpreting piezoelectric signals. In this case, the control system may be programmed to recognize specific voltage thresholds corresponding to desired pressure levels. When a signal exceeding a threshold is detected, the control system may trigger a relay or a similar device to turn the heating element on or off. Based on real-time data from the piezoelectric sensors 130, a feedback loop may be established to maintain heating or adjust heating to maintain a desired temperature or operating condition.

Hereinafter, the heating assembly 200 according to an embodiment of the present invention will be described with reference to FIGS. 2, 4, and 5.

The heating assembly 200 may include a heat transfer plate 210, a film heater 220, and a cover plate 230.

The heat transfer plate 210 is formed in a plate shape, and may be installed such that one surface thereof faces a concrete placement region. In this case, the heat transfer plate 210 is preferably formed of a metal material having high thermal conductivity in order to effectively transfer heat of the film heater 220.

Referring to FIG. 4, at least one film heater 220 may be positioned on the other side of the heat transfer plate 210. That is, the film heater 220 is positioned between the heat transfer plate 210 and the cover plate 230, and may receive power through wires 222. For example, as shown in FIG. 4, four film heaters 220 may be provided, but the number of film heaters 220 is not limited thereto.

In addition, the film heater 220 may be manufactured using a polyimide material. Meanwhile, since the polyimide material has high electrical insulation properties and flame retardancy, it is used in aircraft or automobile engines, and accordingly has effects of high mechanical strength, impact resistance, and dimensional stability. However, the present invention is not limited thereto, and the film heater 220 may be replaced with PET (polyethylene terephthalate), as necessary.

[Table 1] below is a table showing detailed characteristics of the film heater 220.

TABLE 1

| | |
|---|---|
| Temperature range | −50~200° C. |
| Materials | Polyimide |
| Thickness | 0.3 mm≤ |
| Available Input Voltage | DC/AC |
| Withstand Voltage | AC 1000 V |
| Insulation Resistance | 1000 |
| Resistance tolerance | At 25° C. in open air ± 10% |
| Max. Operating Watt Density | At 25° C. in open air, 1 W/cm2 |

The cover plate 230 may be positioned on the other side of the film heater 220. In addition, referring to FIG. 2, the cover plate 230 may be installed such that one side surface thereof is in close contact with a surface of the heat transfer plate 210 on which the film heater 220 is positioned. In addition, referring to FIG. 5, a wire groove 232 through which wires 222 supplying power to the film heater 220 pass may be formed in the cover plate 230. Referring again to FIG. 2, the heat-generating curing system for concrete 10 may further include a lower assembly 400 including a plurality of support frames 410 positioned below the heating assembly 200 and configured to support the heating assembly 200 so that the heating assembly 200 is in close contact with the plate portion 110 of the upper assembly 100.

In addition, referring to FIG. 6, a power receiving unit 420 in a form of an outlet to which wires 222 supplying power to the heating assembly 200 are connected may be positioned in the lower assembly 400, and a power transmitting unit 320 in a form of a plug to be inserted into the power receiving unit 420 may be positioned at an end of a power supply line 310 of the power supply unit 300. In this case, power may be supplied to the heating assembly 200 by inserting the power transmitting unit 320 into the power receiving unit 420. However, the present invention is not limited thereto, and the power receiving unit 420 may be formed in a plug shape, and the power supply unit 300 may be formed in an outlet shape.

In addition, the present invention may include at least one selected from an external temperature sensor configured to measure an external temperature, a humidity measurement sensor configured to measure external humidity, and an internal temperature sensor configured to measure an internal temperature of concrete. In addition, the control unit may control a heating temperature and a heating time of the heating assembly 200 based on sensing values received from the sensors. Furthermore, the control unit may evaluate a curing state of concrete based on the sensing values received from the sensors.

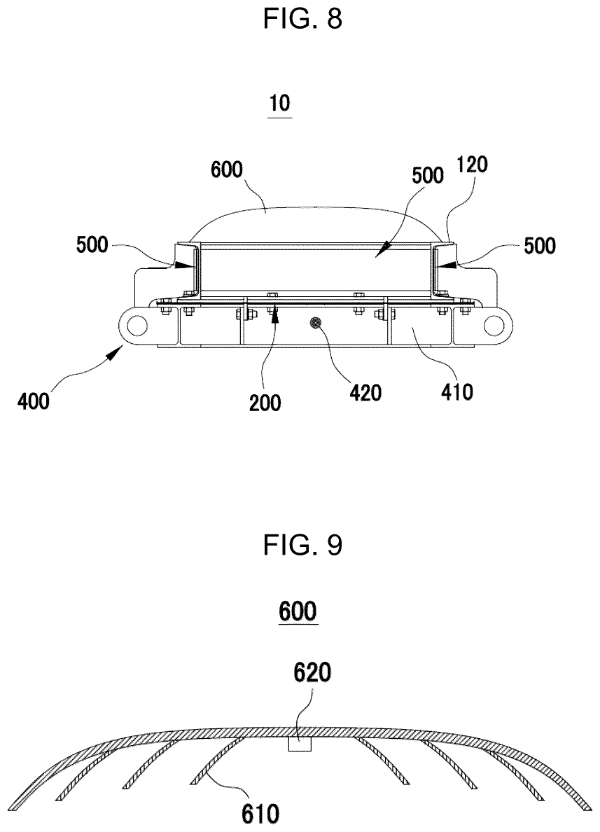

FIG. 7 is a plan view and a partially enlarged view of a heat-generating curing system for concrete according to another embodiment of the present invention, FIG. 8 is a front view of a heat-generating curing system for concrete according to another embodiment of the present invention, and FIG. 9 is a cross-sectional view of a cover portion according to an embodiment of the present invention.

Hereinafter, a heat-generating curing system for concrete according to another embodiment of the present invention will be described with reference to FIGS. 7 to 9.

The heat-generating curing system for concrete 10 according to another embodiment of the present invention has the same configuration as the heat-generating curing system for concrete 10 according to an embodiment, but is characterized by further including a side heating assembly 500.

The side heating assembly 500 may be positioned in close contact with each of the peripheral frames 120, may generate heat by receiving power from the power supply unit 300, and may be formed in a plate shape. That is, the side heating assembly 500 has the same configuration as the heating assembly 200 positioned in close contact with the plate portion 110, and may be positioned in close contact with the peripheral frames 120 to deliver heat to side surfaces of the placed concrete. In FIG. 7, the side heating assemblies 500 are respectively positioned on four peripheral frames 120 to include four side heating assemblies 500; however, the number of side heating assemblies 500 is not limited thereto and may be variously formed according to a shape or a number of the peripheral frames 120.

In addition, the heat-generating curing system for concrete 10 according to another embodiment of the present invention may further include a cover portion 600 coupled to upper portions of the plurality of peripheral frames 120 and positioned to cover an entire upper portion of a space in which concrete is placed. For example, the cover portion 600 may be manufactured of a stainless-steel material and may be fixed through fastening members such as bolts of the peripheral frames 120, but the present invention is not limited thereto.

As shown in FIG. 8, the cover portion 600 may be coupled to upper portions of the peripheral frames 120, have a dome shape, and be formed such that a predetermined space is formed between an inner surface of the cover portion 600 and the placed concrete.

By using the cover portion 600, heat energy and moisture are maintained inside during a curing process of concrete, thereby not only minimizing energy loss and shortening curing time, but also minimizing drying shrinkage, thereby providing an effect of reducing additional finishing work.

The cover portion 600 may further include a cover heating unit (not shown) configured to deliver heat to an internal space formed by the cover portion 600. For example, the cover heating unit may be positioned on an outer surface or an inner surface of the cover portion 600, and may be manufactured to have the same configuration as the heating assembly 200, but the present invention is not limited thereto.

The cover heating unit serves to deliver heat to a space formed between the cover portion 600 and the placed concrete, thereby preventing moisture generated during a hardening process of the concrete from drying.

A humidity measurement sensor 620 configured to measure humidity of an internal space formed by the cover portion and/or an internal temperature sensor (not shown) configured to measure a temperature of the internal space may be positioned on an inner surface of the cover portion 600. In this case, the control unit may control a temperature of the cover heating unit based on information received from the humidity measurement sensor 620 and/or the internal temperature sensor positioned on the cover portion 600.

Referring to FIG. 9, the cover portion 600 may include a plurality of branch portions 610 having ends extending from an inner surface of the cover portion 600 toward an interior thereof and having a predetermined area. The branch portions 610 are designed in a branched distribution structure like tree branches, and may extend outward from a central portion of the cover portion 600. For example, each branch portion 610 may be formed in a donut shape or formed in a polygonal plate shape having a predetermined area, but the present invention is not limited thereto.

Moisture generated during a hardening process of concrete is condensed on the inner surface of the cover portion 600 and surfaces of the branch portions 610, and moisture may be supplied to the concrete through ends of the branch portions 610 by gravity. Accordingly, drying of the concrete hardening in the internal space of the cover portion 600 can be prevented.

The above-described description of the present application is for illustrative purposes, and those skilled in the art to which the present application pertains will understand that various modifications can be easily made without changing the technical spirit or essential features of the present application. Therefore, the embodiments described above should be understood in all respects as illustrative and not restrictive. For example, each component described in a singular form may be implemented in a distributed manner, and likewise, components described as being distributed may also be implemented in a combined form.

The scope of the present application is defined by the claims to be described later rather than the foregoing detailed description, and all changes or modifications derived from the meaning and scope of the claims and equivalents thereof should be interpreted as being included in the scope of the present application.

Description of Reference Numerals

| | |
|---|---|
| 10: Heat-generating curing | |
| system for concrete | |
| 100: Upper assembly | |
| 110: Plate portion | 120: Peripheral frame |
| 130: Piezoelectric sensor | |
| 200: Heating assembly | |
| 210: Heat transfer plate | 220: Film heater |
| 222: Wire | 230: Cover plate |
| 300: Power supply unit | 310: Power supply line |
| 320: Power transmitting unit | |
| 400: Lower assembly | |
| 410: Support frame | 420: Power receiving unit |
| 500: Side heating assembly | |
| 600: Cover portion | 610: Branch portion |

What is claimed is:

1. A heat-generating curing system for concrete, comprising:
an upper assembly including a plate portion formed in a plate shape and a plurality of peripheral frames coupled to the plate portion, wherein a predetermined space is formed therein so that concrete is placed therein;
a plate-shaped heating assembly positioned in close contact with one side surface of the plate portion and configured to generate heat by power supply;
a power supply unit configured to supply power to the heating assembly; and
a control unit configured to control a heating temperature and a heating time of the heating assembly,
wherein the upper assembly includes a plurality of piezoelectric sensors configured to measure a weight of concrete placed in the predetermined space, and
wherein the control unit controls the heating assembly based on information received from the plurality of piezoelectric sensors.

2. The heat-generating curing system for concrete of claim 1, wherein the heating assembly includes:
a plate-shaped heat transfer plate having one surface facing a concrete placement region;
at least one film heater positioned on another surface of the heat transfer plate; and
a cover plate positioned on another side of the film heater.

3. The heat-generating curing system for concrete of claim 2, wherein the cover plate has a wire groove through which a wire supplying power to the film heater passes.

4. The heat-generating curing system for concrete of claim 1, further comprising a lower assembly including a plurality of support frames positioned below the heating assembly and configured to support the heating assembly so that the heating assembly is in close contact with the plate portion of the upper assembly.

5. The heat-generating curing system for concrete of claim 4, wherein a power receiving unit in a form of an outlet to which a wire supplying power to the heating assembly is connected is positioned in the lower assembly,
wherein an end of a power supply line of the power supply unit includes a power transmitting unit in a form of a plug to be inserted into the power receiving unit, and
wherein power is supplied to the heating assembly by inserting the power transmitting unit into the power receiving unit.

6. The heat-generating curing system for concrete of claim 1, further comprising at least one selected from:
an external temperature sensor configured to measure an external temperature;
a humidity measurement sensor configured to measure humidity; and
an internal temperature sensor configured to measure a temperature inside the concrete,
wherein the control unit controls the heating assembly based on sensing values received from the sensors.

7. The heat-generating curing system for concrete of claim 1, further comprising a plate-shaped side heating assembly positioned in close contact with an outer surface of each of the peripheral frames and configured to generate heat by receiving power from the power supply unit.

8. The heat-generating curing system for concrete of claim 1, further comprising a cover portion coupled to upper portions of the plurality of peripheral frames and positioned to cover an entire upper portion of a space in which concrete is placed.

9. The heat-generating curing system for concrete of claim 8, wherein the cover portion further includes a cover heating unit configured to deliver heat to an internal space formed by the cover portion.

10. The heat-generating curing system for concrete of claim 8, wherein a humidity measurement sensor configured to measure humidity of an internal space formed by the cover portion and/or an internal temperature sensor configured to measure a temperature of the internal space is positioned on an inner surface of the cover portion.

11. The heat-generating curing system for concrete of claim 8, wherein the cover portion includes a plurality of branch portions having ends extending from an inner surface of the cover portion toward an interior thereof and having a predetermined area.
